(19) United States
(12) Patent Application Publication
(10) Pub. No.: US 2017/0057271 A1
(43) Pub. Date: Mar. 2, 2017

(54) METHOD FOR MAKING BOOKS

(71) Applicants: Artron Art (Group) Co., Ltd., Shenzhen (CN); Beijing Artron Graphic Art Co., Ltd., Beijing (CN); Shanghai Artron Graphic Art Co., Ltd., Shanghai (CN)

(72) Inventor: Xiaobin Wang, Shenzhen (CN)

(73) Assignees: Artron Art (Group) Co., Ltd.; Beijing Artron Graphic Art Co., Ltd.; Shanghai Artron Graphic Art Co., Ltd.

(21) Appl. No.: 15/338,378

(22) Filed: Oct. 29, 2016

Related U.S. Application Data
(63) Continuation of application No. PCT/CN2015/092433, filed on Oct. 21, 2015.

(30) Foreign Application Priority Data
Aug. 26, 2015 (CN) 201510532858.7

(51) Int. Cl. B42C 19/00

(52) U.S. Cl. CPC B42C 19/00

(57) ABSTRACT

A method for making a book is provided in the embodiments of the present invention. The method mainly comprises: cutting printed sheets for a book, brushing glue onto edges of the printed sheets, bonding the printed sheets through the glue, and positioning and fixing a plurality of bonded printed sheets by utilizing a right-angled mold; perforating each, of the positioned and fixed printed sheets, and stringing holes of the printed sheets so as to reinforce the printed sheets; and splicing front endpaper and rear endpaper onto endpaper connection cloth, and then, bonding the endpaper and bookblocks. The embodiments of the present invention adopt a right-angled mold to position register and fix a plurality of bonded printed sheets, and pages are unlikely to dislocate, thereby guaranteeing the binding quality of the book, improving the attractiveness of the book, reducing a making time of the book, and improving the production efficiency of the book. The method of the present invention can break through a size limitation of a traditional book at 787*544 mm, thereby making a book of a greater size.

### CROSS-REFERENCE TO RELATED APPLICATIONS

This application is a continuation of International Patent Application No. PCT/CN2015/092433 with a filing date of Oct. 21, 2015, designating the United States, now pending, and further claims priority to Chinese Patent Application No 201510532858.7 with a filing date of Aug. 26, 2015. The content of the, aforementioned applications, including any intervening amendments thereto, are incorporated herein by reference.

### TECHNICAL FIELD

The present invention relates to the technical field bookmaking, in particular to a method for making a large-sized book.

### BACKGROUND OF THE PRESENT INVENTION

At present, in a traditional method for making a book, adhesive bonding is conducted generally by gluing, so after being frequently browsed, pages of the book are likely to drop. Moreover, there is no dedicated mold for registration in the traditional book making method, which is likely to lead to the dislocation of the pages when bonded. As a result, negative influences are exerted on the quality and attractiveness of the book, and the making time is, greatly increased while the production efficiency is decreased. What's more, the size of a book is limited to 787*544 mm or below by the breadth of a folding machine, a book sewing machine and the like in the traditional method.

Therefore, to develop a high-efficiency method for making a large-sized book is a problem to be solved.

### SUMMARY OF PRESENT INVENTION

A method for making a book is provided in the embodiments of the present invention, which aims at effectively making a large-sized book.

In order to achieve the above objective, the present invention adopts a technical solution as follows.

A method for making a book comprises:

printed sheets are cut for the book, glue is brushed onto edges of the printed sheets, the printed sheets are bonded with glue, and the bonded printed sheets are positioned and fixed by utilizing a right-angled mold; and

holes are drilled on the positioned and fixed printed sheets, and are stringed to reinforce the printed sheets.

Preferably, after the printed sheets are reinforced by stringing the holes of the printed sheets, the method further includes: front endpaper and rear endpaper are spliced onto an endpaper connection cloth and then are bonded with the bookblock.

Preferably, after the endpapers and the bookblock are bonded, the method further includes: three sides are cut for the bookblock of each printed sheet, i.e. head margin, foot margin and fore-edge.

Preferably, after the three sides of the bookblock, i.e. the head margin, the foot margin and the fore-edge are cut, the method further includes; head bands are bonded to the end of a head margin or a foot margin adjacent to the back.

Preferably, the method further includes: a layer gauze bonded onto the book spine.

Preferably after the layer of gauze is bonded onto the book spine, the method further includes: a 45-degree-angle V groove is formed on a back board of the book, then a cotton string is bonded, and case face paper is coated.

Preferably, after a cover making process of the book is completed, the method further includes: the book spine is fixed by utilizing glue with a special book spine fixing mold, and the glue is dried for a set time.

Preferably, after the glue is dried for a set time, the method further includes: the front cover is filled and leveled up, and then sweeping lining is conducted.

It can be seen from the technical solution provided in the embodiments of the present invention that bonded printed sheets are positioned, registered and fixed by a right-angled mold, and the pages are unlikely to dislocate, so that the binding quality of the book is guaranteed, the attractiveness of the book is improved, a making time of the book is decreased, and the production efficiency of the book is increased. A size limitation of the traditional book at 787*544 mm can be broke through, and a greater size book can be made with the method provided in the present invention.

Additional aspects and advantages of the present invention are partially provided in the following description, and these aspects and advantages can become apparent in the following description or can be known through the practice of the present invention.

### DESCRIPTION OF THE DRAWINGS

In order to state a technical solution of embodiments of the present invention more clearly, drawings used in the description of the embodiments are simply introduced below; and apparently, the drawings in the following description are only partial embodiments of the present invention, and those ordinary skilled in the art can obtain other drawings on the premise of not contributing innovative work.

FIG. 1 is a processing flow diagram showing a method for making a large-sized book provided in embodiments of the present invention;

FIG. 2 is a schematic top view showing cutting and glue brushing of printed sheets provided in embodiments of the present invention;

FIG. 3 is a schematic top view showing hole drilling and hole stringing of the printed sheets provided in embodiments of the present invention;

FIG. 4 is a schematic side view and a top view showing bonding endpaper of the book provided in embodiments of the present invention;

FIG. 5 is a schematic diagram showing cutting a finished product for a book provided in embodiments of the present invention;

FIG. 6 is a schematic perspective view showing bonding head band and gauze for a book provided in embodiments of the present invention;

FIG. 7 is a schematic diagram showing making a cover for a book provided in embodiments of the present invention:

FIG. 8 is a schematic diagram showing fixing a back for a book provided in embodiments of the present invention; and

FIG. 9 is a schematic diagram showing on-site placement of finished products for a book provided in embodiments of the present invention

### LIST OF REFERENCE NUMBERS IN THE DRAWINGS

10 single sheet of silk screening glue (for example 9830 yellow adhesive)

20 hole (hole obtained by adopting a φ2MM twist drill)

30 string (cotton string)

40 single endpaper

50 connection cloth

60 head margin

70 spine

80 foot margin

90 book fore-edge

100 head band

101 gray board

102 wood board

103 face paper

104 V groove folding board

105 cotton string (for example φ4 mm cotton string)

106 bookblock

107 spine back

108 mold

109 cover

200 adhesive tape

300 gauze

400 wood board

500 finished product

### DETAILED DESCRIPTION OF PREFERRED EMBODIMENTS

Embodiments of the present invention are described in detail below, examples of the embodiments are shown in the drawings, and identical or similar numbers always represent identical or similar elements or elements having identical or similar functions. The embodiments described below with reference to the drawings are exemplary and are only used to explain the present invention but not to limit the present invention,

Those skilled in the art can understand that unless specifically declared, a single form used herein such as “a”, “one”, “the” and “said” also includes a plural form. It should be further understood that the word “include” used in the DESCRIPTION of the present invention refers the existence of features, integers, steps, operations, elements and/or components, but does not exclude the existence or addition of one or more other features, integers, steps, operations, elements, components and/or a group thereof. It should be understood that when the element is “connected” or “coupled” to another element, the element can be directly connected or coupled to other elements, or an intermediate element also can be provided. In addition, the “connection” or the “coupling” used herein can include wireless connection or coupling. The word “and/or” used herein includes any unit and all combinations of one or more associated listed items.

Those skilled in the prior art can understand that unless otherwise specified, all terms (including technological terms and scientific terms) used herein have a same meaning with a general understanding of those ordinary skilled in the art of the present invention. It should also be understood that the terms defined in a universal dictionary shall be understood to have the meaning consistent with the meaning in a bookblock of the prior art; and unless as defined herein, the terms may not be interpreted by utilizing an ideal or a formal meaning.

In order to understand the embodiments of the present invention, the present invention is further stated below by taking several specific embodiments as examples with reference to the drawings; and moreover, the embodiments do not limit the embodiments of the present invention.

### Embodiment 1

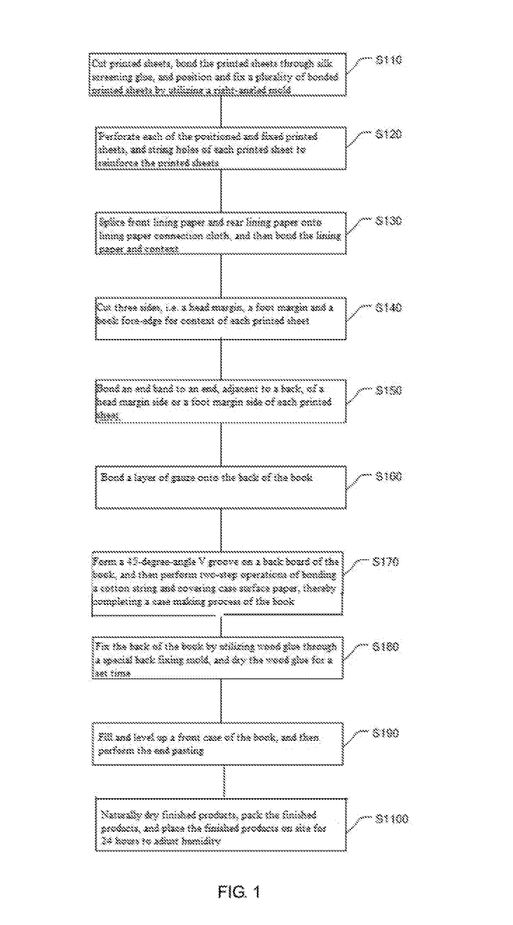

The present embodiment provides a processing flow of a method for making a large-sized book is as shown in FIG. 1, including the following processing steps;

In the step S110, the printed sheets are cut, and then bonded by silk screening glue, and then positioned and fixed by a right-angled mold.

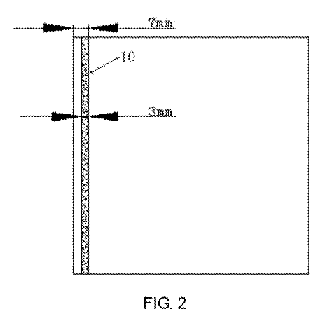

schematic top view showing cutting and glue brushing of printed sheets and positioning and fixing of the printed sheets with a right-angled mold is as shown in FIG. 2, and this step shall be executed strictly according to a criterion on the following three aspects:

1. a criterion for cutting the printed sheets: a size error range of each edge of the printed sheets after being cut is ±0.05 mm;

2. glue brushing: using silk screen printing machine for glue brushing, and a thickness of the glue is controlled between 8 μ-10 μ, because excessively thick glue may cause the deformation of the paper. And the reference number 10 in the FIG. 2 represents a single sheet of silk screening glue (for example 9830 yellow adhesive); and

3. page bonding: bonded printed sheets are positioned and fixed with a right-angled mold which plays a role in fixing; sheets stacked together are placed on the right-angled mold in FIG. 2, and the bonded printed sheets can be fixed in both a length direction and a width direction through the right-angled mold.

The right-angled mold is in a right-angled three-dimensional shape, of which the size can be adjusted according to a size of a sample sheet; and before the use, the right-angled mold is cleaned to ensure that there is no dirt the precise stacking of the printed sheets.

In this way, the smoothness of the book can be guaranteed, the making difficulty can be alleviated, and the product quality can be improved. The pages are bonded to form a book-block through this way, so that a neatness error can fall within a range of ±0.1 mm.

In the step S120, the positioned and fixed printed sheets are perforated, and holes of the printed sheets are stringed to reinforce the printed sheets.

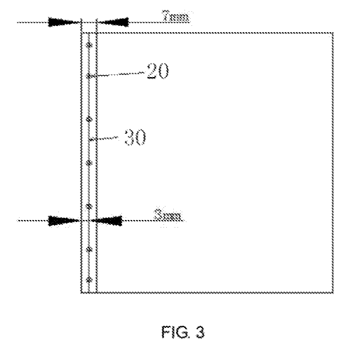

A schematic top view showing perforation and hole stringing of printed sheets provided in the embodiment of the present invention is as shown in FIG. 3. Holes of printed sheets are stringed, and these steps should be carried out strictly according to a criterion on the following two aspects.

1.hole drilling for bookblock: a diameter of each hole 20 is controlled within 2.5 mm, for example, the hole is drilled by utilizing a 2MM twist drill.

2. Hole stringing: a string 30 (cotton string) is stayed among the holes to improve the firmness of the book.

The printed sheets can be drilled in several parts separately and then combined into a book by string, which can break through a limitation to the thickness of the book-block by a traditional back gluer, and the thickness of the book-block can reach 200 mm or above. The stringing is to improve the firmness of the book.

In the step S130, endpaper is bonded:

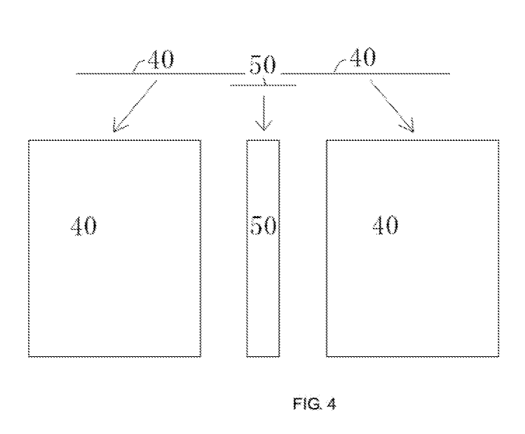

a schematic side view and a top view showing bonding endpaper of a book provided in the embodiments of the present invention are as shown in FIG. 4; and in FIG. 4, the side view and the top view showing the bonding of the endpaper of the book are respectively above and below the arrow. Since it is specially developed for a large size book, it requires very high strength of the endpaper 40. Therefore, to enhance the strength of the endpaper and avoid its fracture, the front endpaper and the rear endpaper are spliced onto a layer of endpaper connection cloth 50. Then the endpaper and the book block 106 are bonded.

In the present invention, books can be made in larger sizes, sheets are bonded page by page, and the contents of the books are printed by high-precision digital printing machines or large-breadth high-precision printing machines.

By utilizing the cloth, the strength of the endpaper is improved, the fracture of the endpaper is prevented, and the strength of the endpaper is guaranteed.

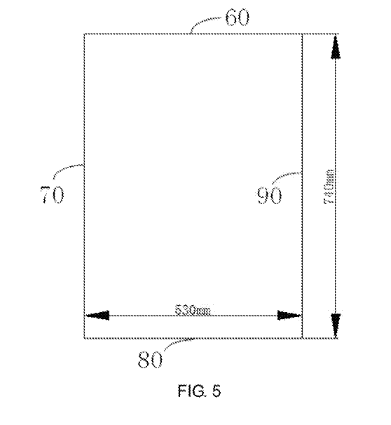

In the step S140, a schematic diagram showing cutting a finished product for a book provided in the embodiments of the present invention is as shown in FIG. 5. Cutting the finished product mainly includes cutting three sides, i.e. a head margin 60, a foot margin 80 and a book fore-edge 90 for the bookblock of each printed sheet (530*740 mm), and the phenomenon such as cutting traces, deflection, skewing, trapezoid and the like should be avoided, which may cause negative effect on the quality of the book. A main target customer group of the present invention is high-end customers whose expectations for the practicability and attractiveness of the product are higher. The head band is bonded not only on the back but also on the head margin and the foot margin, adjacent to the back of the book, so that the attractiveness of the book is guaranteed, and the wearing of the head margin and the foot margin during used can be alleviated. In addition, a layer of gauze is bonded to the back (such as the spine 70). Thus the firmness of the spine of the book is improved, the quality of the finished products is guaranteed, and the drop of pages is avoided.

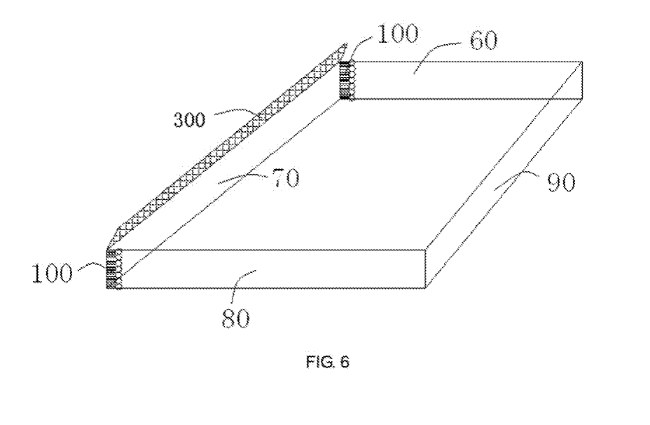

In the step S150, a schematic prospective view showing bonding of head band 100 and a gauze 300 of the book provided in the embodiments of the present invention is as shown in FIG. 6. In order to make the book more attractive, the head band is bonded. Different from the traditional way, the head band is bonded on the head margin and the foot margin, adjacent to the back of the book. The length of the head band on the head margin or the foot margin can be 4 mm.

A layer of gauze 300 is bonded to the back of the book to increase the firmness of the book spine.

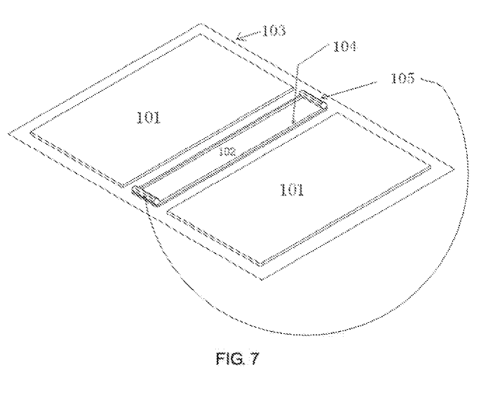

In the step S160, a schematic diagram showing case-making provided in the embodiments of the present invention is as shown in FIG. 7. In a traditional case making process, when a back spine board is formed, a right angle is formed by a machine, the book case would be ragged and unattractive after the splicing on one hand, and on the other hand, the bonding would be weak resulted from the smaller adhesive surface.

A case-making process provided in the embodiments of the present invention is as follow: a 45-degree-angle V groove s formed on the back board of the book by a machine (refer to a V groove folding board 104 in FIG. 7), and then a φ4 mm cotton string 105 is bonded and case face paper 103 is coated, thereby completing the case eking, process of the book. A 45-degree angle is formed on the back board.

A layer of wood board 102 (can also be gray board PVC board and the like) is fitted to a back position of a cover (case) to further improve the strength of the book spine. Two ends of this layer of wood board are respectively bonded with a section of cotton string so as to further fix the wood board onto the case, which could improve both the quality and an artistic taste of the book.

A process of coating the case is to combine the cloth with the gray board 101 and finally form a front cover and back cover of the book.

The present invention adopts an embedded back position method, so that the appearance of the finished product is ensured to be the same with a normal hardcover book, and any process for processing the bookblock back position cannot be seen. The present invention not only guarantees the appearance attractiveness of the finished product, but also further improves the firmness of the case by improving the process.

The gray board used in the front cover and the back cover of the large size book can also be replaced by other materials such as a wood board, a PVC board and the like; and the cover materials of the case can be cloth, special paper, laminated paper and so on.

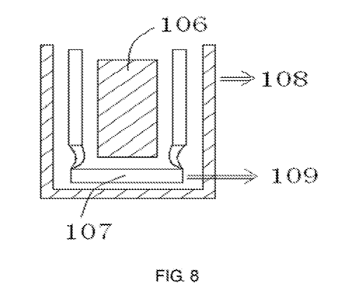

In the step S170, a schematic diagram showing back fixing (i.e. fixing the spline 107) of a book provided in the embodiments of the present invention is as shown in FIG. 8. In a traditional process, deformation of the bookcase may be caused during back fixing due to the weight of the case 109. In the present invention, back fixing is carried out in a special back fixing mold 108, and wood glue used is dried for a set time, through which the deformation can be avoided.

The back fixing mold is a cuboid with one side open, of which the size can be flexibly set to meet the requirement of books made in different sizes.

The wood glue can be 750 wood glue that shall be dried for at least 8 hours. In the present invention, a dedicated mold is adopted, combined with a fixing back process, that is, the spine of bookblock is combined firmly with the case without any space, to avoid the deformation of the case 109 and improve the firmness of the finished product in addition.

In the step S180, a method for sweeping lining of a book is provided in the embodiments of the present invention, the case of the book is filled and leveled up before lining sweeping. Overhang cover edges of three sides are ensured to be uniform in width.

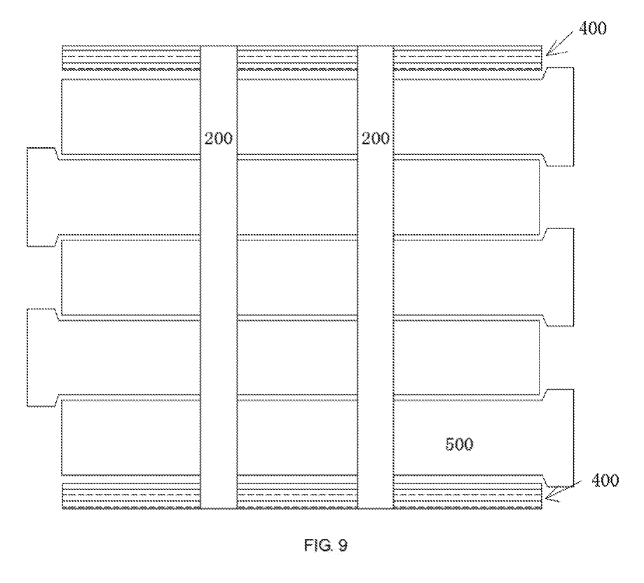

In the step S190, a schematic diagram showing onsite placement of finished products of the book provided in the embodiments of the present invention is as shown in FIG. 9. When in on-site placement, the finished products 500 are naturally dried. The finished products 500 are stacked except for the back, leveled by the wood board 400 (the backs are staggered), packed by utilizing adhesive tapes 200, and placed on site for 24 hours for humidity adjustment.

In conclusion, a right-angled mold is used to position, register and fix a plurality of bonded printed sheets in the embodiments of the present invention. As a result, the pages are unlikely to be dislocated, the binding quality of the books is guaranteed, the attractiveness of the books are improved, as well as decreasement of the making time and increasement of the production efficiency. A size limitation of the traditional book at 787*544 mm can be broken through, and thereby books of a greater size can be obtained through the method in the present invention.

The pages are connected by hole drilling and hole stringing in the embodiments of the present invention, so that the pages are unlikely to drop. The head band is bonded on the head margin and, the foot margin, adjacent to the back, so that the attractiveness of the book is guaranteed, and wearing of the head margin and the foot margin of the book during used is alleviated. And a layer of gauze is, bonded to the back, so that the firmness of the book back is improved, the quality stability of the formed large book finished product is ensured, and the dropping of pages is avoided.

Through the method in the embodiments of the present invention, not only the appearance attractiveness of the finished product is guaranteed, but also the firmness of the case is improved. A dedicated mold is adopted in the present invention, combined with a fixing back process, to avoid the deformation of the case and further to improve the firmness of the finished product. The front endpaper and the rear endpaper are spliced onto a layer of cloth, through which the strength of the endpaper is strengthened, and the fracture of the endpapers is avoided.

Those ordinary skilled in the art can understand that: the drawings are only schematic diagrams of one embodiment, and modules or flows in the drawings are not necessary for implementing the present invention.

By means of the above description of the embodiments, those skilled in the art can clearly know that the present invention can be realized by virtue of software with necessary universal hardware platforms. Based on this comprehension, the technical solution or the portion making contribution to the prior art can be substantively reflected in a form of a software product; and a computer software product can be stored in a computer readable storage medium such as ROM/RAM, a diskette, a compact disk and the like, and includes a plurality of instructions used, to instruct a computer device (a personal computer, a server or a network device and the like) to execute various embodiments or methods described in partial embodiments of the present invention.

All embodiments of the present invention are described in a progression manner, identical or similar parts of all embodiments can mutually refer to each other, and a key point of each embodiment is the difference from other embodiments. Particularly, embodiments of an apparatus or a system are basically similar to the embodiments of the method, so that the description is relatively simple, and relatedness can refer to partial statement of the embodiments of the method. The above-mentioned apparatus and system embodiments are only illustrative wherein the unit illustrated as a separated part may be or may riot be physically separated, a part displayed as a unit may be or may not be a physical unit, i.e. the part can be disposed at a same place or can also be distributed on a plurality of network units. The objective of the solution of the present embodiment can be realized by selecting partial or all modules according to a real need. Those ordinary skilled in the art can understand and implement the embodiments in the case of not contributing innovative work.

The above description is only preferred specific embodiments of the present invention, but does not limit a protection scope of the present invention; and any changes or replacements capable of being easily conceived by those skilled in the art in the technical scope disclosed in the present invention should fall within the protection scope of the present invention. Therefore, the protection scope of the present invention should be subjected to the protection scope of the appended claims.

I claim:

1. A method for making a book, characterized by comprising:
cutting printed sheets, brushing glue onto edges of the printed sheets, bonding the printed sheets through the glue, positioning and fixing the printed sheets with a right-angled mold; and
perforating each of the positioned and fixed printed sheets, and to reinforce each printed sheet by stringing the holes.

2. The method for making the book according to claim 1, characterized by further comprising after the holes of each printed sheet are stringed to reinforce the printed sheets: splicing front endpaper and rear endpaper onto endpaper connection cloth, and then bonding the endpaper and bookblocks.

3. The method for making the book according to claim 2, characterized by further comprising after the endpaper and the bookblocks are bonded: cutting three sides, a head margin, a foot margin and a book fore-edge for the bookblocks of each printed sheet.

4. The method for making the book according to claim 3, characterized by further comprising after three sides, i.e. the head margin, the foot margin and the book fore-edge are cut for the bookblock of each printed sheet: bonding an end band to the end, adjacent of a back, of a head margin side or a foot margin side of the bookblock of each printed sheet.

5. The method for making the book according to claim 1, characterized by further comprising: bonding a layer of gauze to the back of the book.

6. The method for making the book according to claim 5, characterized by further comprising after the layer of gauze is bonded to an upper portion of the back of, the book: forming a 45-degree-angle V groove on a back board of the book, then bonding a cotton string and covering case face paper.

7. The method for making the book according to claim 6, characterized by further comprising after a case making process of the book is completed: fixing the back of the book by utilizing wood glue through a back fixing old, and drying the wood glue for a set time.

8. The method for making the book according to claim 7, characterized by further comprising after the wood glue is dried for a set time: filling and leveling up a front case of the book, and then performing end pasting.
